(19) United States
(12) Patent Application Publication
(10) Pub. No.: US 2006/0226665 A1
(43) Pub. Date: Oct. 12, 2006

(54) Collision impact force mitigating device

(76) Inventor: Ming Yat Kwok, Vancouver (CA)

Correspondence Address: Ming Yat Kwok, 1646 Frances St., Vancouver, BC, V5L 1Z4, CA

(21) Appl. No.: 11/100,236

(22) Filed: Apr. 6, 2005

(51) Int. Cl. B60R 19/04

(52) U.S. Cl. 293/155

(57) ABSTRACT

A collision impact force mitigating device comprises of a stationary bottom (20) bolted to the frame (30) of a vehicle, and a slider top (10) attached to which is the calibration bar (15) with its cover (11) removed to show the numerous through slots (19) for calibration. A flange (14) is for mounting a force plate or bumper to the device. Insert bar (12) with numerous calibrated through slots also includes a collapsible sleeve (13) and a curve-out flex plate (18). Hard wares (16) are for tightening the slider top in place with calculated pressure.

### BACKGROUND—FIELD OF INVENTION

The present invention relates to a collision impact force mitigating device and as support structure of bumpers for vehicles.

### BACKGROUND—DESCRIPTION OF PRIOR ART

The present day impact absorbing value of some of the vehicles are by installation of bumpers with their support system, such as, suv, pickups, and trucks. Those more stylist models are designed to buckle up to the engine to absorb impact force. They are of limited effect in low speed but very costly and the latter not very successful at all in high speed once it buckled right up to the engine compartment.

Other design of force mitigating systems such as U.S. Pat. No. 6,371,541 (2002) to Ronald Helland Pedersen showing a bracket made of metal with elongated peel slots and long big bolts that shear the walls of the bracket which fitted within is part of the vehicle frame. The long big bolts that go against the walls will have to stand a very high compression point before their shearing action begin, and once they started it will not take too much force to shear because they are uniform, and to fit frames of all make into the shearing bracket will be very costly if not impossible.

In U.S. Pat. No. 5,732,801 (1998) to David C. Gertz showing an energy absorbing structure include a hollow cylinder with stamped pattern on the cylinder wall for initiating an indented buckling from the impact force, they are directly mounted inline at the tip of the vehicle frame. A long hollow cylinder will stick out too much and will be unsightly and a short cylinder will not have much absorbing effect, and thin wall cylinders will not effectively support the bumper and expected extra load, and thick wall cylinders will not absorb much impact.

In U.S. Pat. No. 4,272,114 (1981) to Tomoyuki Hirano showing a hollow polyhedral body as an impact absorbing device which has cutouts to assist of deformation and placed at the very end of a vehicle frame. Once this device is compressed it is a solid mass so it has to be a long unit to be of any value and a long unit is not practical for the manufacturers for stylish reasons and the device tends to bend side way when at a slight angle in a collision.

In U.S. Pat. No. 3,934,912 (1976) to Yoshiyuki Ogihara showing an impact force absorbing device by means of hydraulic system. As it is well known that hydraulic system whether using oil or gas which both have volume and volume can not dissipate in a hurry so shock absorption effect is quite limit no matter how the system is manipulated

In U.S. Pat. No. 3,694,019 (1972) to John Ed Carter showing an energy absorbing device by elongating or stretching a thermoplastic structure, such as nylon yarn. The system is not reliable as nylon yarns are affected by the elements and they are not very elastic.

In U.S. Pat. No. 2,186,137 (1937) to C. L. Halladay showing s coil spring fitted to an impact bar and bolted to the elongated slots of the vehicle frame so the impact bar slides backward during a collision. When a coil spring is fully compressed it becomes a solid mass so it has to be a long length to be of some effect.

The present invention acquires the effect of shearing, compressing, jamming, pushing, sliding, peeling, buckling, flexing, chiseling and snapping to mitigate the force of impact during a collision. The present device deploys a stationary plate made of material such as, but not limited to, aluminum, has a push bar at the back end and cubicle blocks and half moon lobes with the straight side facing to the front on the inside surface of the plate and cutout notches at the front end and the plate is bolted down to one side of the frame at the front or back of a vehicle. Bolts to hold the stationary plate down are multiple level, the top level of which is to hold down the slider top plate with elongated variable length slots, the top level of the bolts are compressed down with torque together with lock nuts, flat washers and cone lock washers are to be snapped off one at a time giving enough force with the slider top plate sliding backward which also push out the push bar of the stationary plate. Elongated slots with teeth are to be accommodating the cubicles with peeling and shearing effect when the plate is sliding. The elongated slots of different lengths with straight ends facing backward are to be accommodating the half moon lobes which will be sheared off one at a time. Sharp triangle lobes at one end of the slider top plate are for jamming and chiseling to the guided lines of the notched spots on the stationary plate. Attached to the slider plate is the long calibration bar with numerous carefully arranged through slots where snap rods are placed according to calculation. A flange at the top of the bar facilitate fastening the inside panel of a two panels fixed bumper, there is a curve-out flex plate at one end of the insert calibration bar rests against the outside panel of the bumper so when minor force from a roll bump that the plate will flex and bounce back the bumper. There are also numerous through slots at the insert calibration bar and some of them are elongated so that the rods that contact the force will not snap all at the same time. Snapping rods are made of, but not limit to, aluminum, brass, steel, etc. Rods are to be snapped off three at any one time, one just outside of the flange of the long calibration bar, one joining the two bars together, and one below the insert bar, they are to be snapped off at a slight different timing depends on the kind of make of rods used. The rods are placed through to the other end of the bars, so the force of the impact will snap off two ends of the rods that three rods will have six ends to be snapped off at any one time. After the insert bar is forced into the limit of the calibration bar, the continuous pressure activates the top slider plate sliding backward and effect more force mitigating action. A pre-formed metal sleeve is placed covering the exposed part of the insert calibration bar to keep all the snap rods in place and the dirt out and will be compressed the predictable way and shape without subject to the yield point. The slider top plate, calibration bar and insert bar assembly are made of, but not limit to, steel, it is simple, non high tech, effective, and does not cost a lot to make and materials are already in the market place.

### OBJECTS OF THE INVENTION

It is the object of the invention to utilize the force of shearing, snapping, flexing, compressing, jamming, chiseling, pushing, sliding, buckling and peeling to mitigate its own impact force from a collision. Further to the above is to provide a low cost device and simple to fasten to the existing frame member of the vehicle. Further object of the invention is to lessen the impact from the head-on collision which results to the most fatalities and serious injuries.

### BRIEF DESCRIPTION OF THE DRAWINGS

These and other objects and advantages of the invention will be apparent upon reading the following description in conjunction with the drawings, in which:

FIG. 1 is the collision impact force mitigating device with the cover of the calibration bar off.

FIG. 2 is showing the slider top plate with the calibration bar attached and the insert calibration bar and sleeve separated, showing also the snap rods.

FIG. 3 is showing the collision impact force mitigating device open and also part of a vehicle frame.

### DESCRIPTION OF THE PREFERRED EMBODIMENT

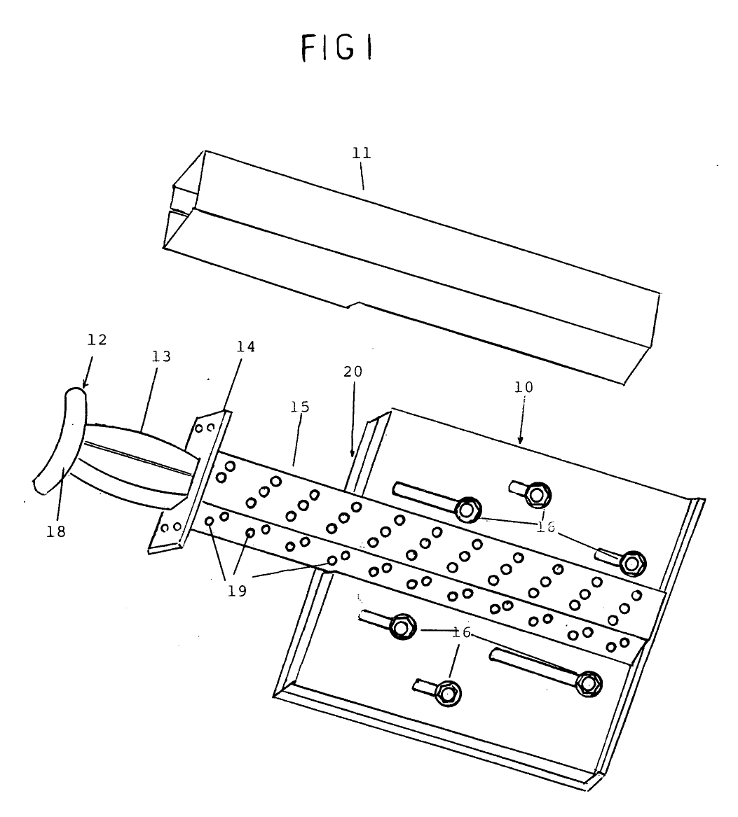

Referring to FIG. 1 showing the collision impact force mitigating device with the cover (11) removed to show the whole calibration bar (15) and the calibration slots (19) which is attached to the slider top plate (10) with the stationary plate (20) at the bottom, hard wares (16) are fastening the two plates together to the vehicle frame (30). An insert calibration bar (12) with curve out flex plate (18) and a pre-formed sleeve (13) is installed through a flange (14) of the calibration bar (15).

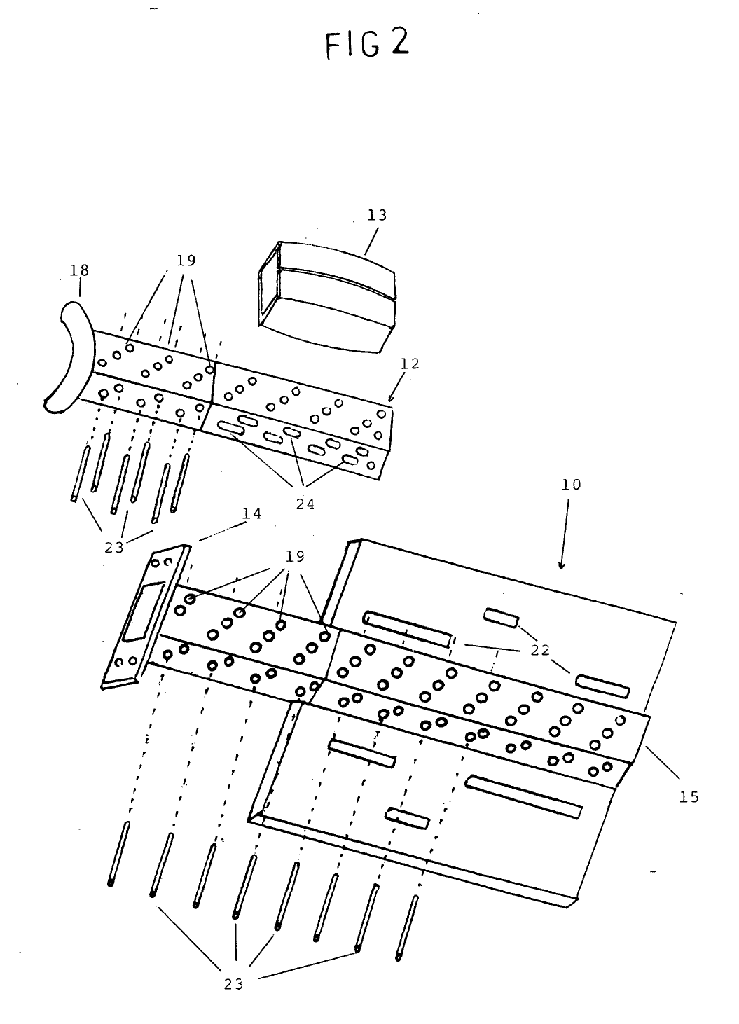

Referring to FIG. 2 is the slider top plate (10) with the insert calibration bar (12) and the sleeve (13) removed to show the numerous round calibration slots (19) and elongated slots (24) and the snapping rods (23). Showing also elongated slots (22) on the slider top plate (10) for sliding backward.

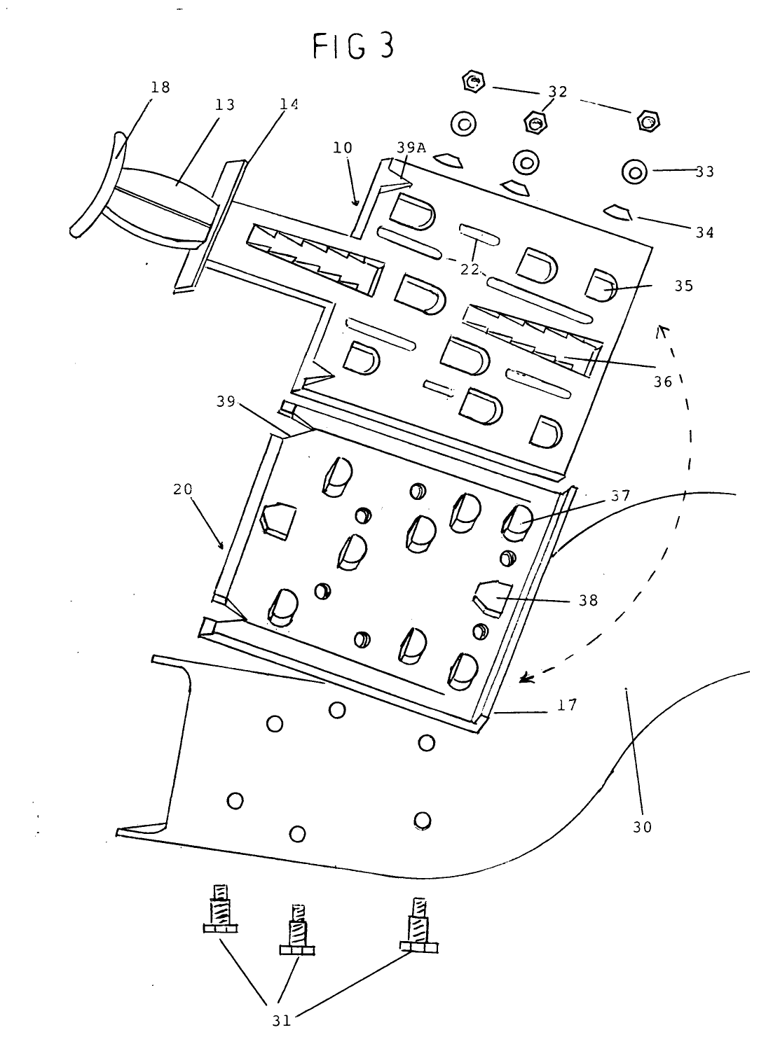

Referring to FIG. 3 is showing the stationary plate (20) and the slider top plate (10) open up to show elongated slots with teeth-shaped cutters (36) are to accommodating the cubicle blocks (38) and each set of cutters peel off one layer of the block when the plate slides backward. Slots (35) with irregular lengths and one side is half moon and the front part is straight they are to accommodate the half-moon lobes (37) and they will be sheared off one at a time. Sharp triangle lobes (39A) at one end of the slider top plate (10) fit into notches (39) and effect jamming and chisel action to guided parts of the stationary plate (20). The retaining bar (17) will be pushed away first thing after the sleeve (13 ), flex plate (18) and the insert calibration bar (12) forced to their limit, snapping rods (23) will also being snapped off at the same time. Multi-level bolts (31) are facilitated to fasten the vehicle frame to the two plates (10) and (20) with lock-nuts (32), flat washer (33) and lock cone washers (34), they are to be tightened down with torque wrench to uniform pressure. The top level of the bolts are to be sheared off together with the hard wares one at a time giving enough force.

### CONCLUSION

Accordingly, the reader will see that a collision with considerable speed will do a lot of damages to the vehicles involved including serious injuries to the occupants. Collision impact force will shear, snap, push, slide, compress, jam, cut, peel and buckle, all or some of the above forces will serious damage a vehicle. The present invention acquired the same forces transmitted to the mitigating device and solved the problems associated with the prior arts, it is of gradual action with stages from low to high speed most of all the device and its force mitigating function is adjustable. It is simple, easy to make and low cost to mass produce and can be fastened to existing structure of the vehicle, and can be adapted to fit other transportation apparatus, such as, but not limit to, bus, trains and aircraft, etc.

Although the description above contains many specifications, these should not be construed as limiting the scope of the invention but as merely providing support to the illustrations of the preferred embodiment of this invention. For example, the calibration and insert bar can be made of other shape of materials such as round tube snapping rods can be of ceramic material etc.

Thus the scope of this invention should not be determined by the appended claims and their equivalents, rather than by the examples given herein.

What is claimed is:

1. A collision impact force mitigating device comprising:
a stationary bottom plate bolted to the side of the frame of a vehicle said plate consists of pre-cut notches assist in directional slicing and jamming means, said plate also including small cubicle blocks functioning as peeling and shearing objects and said plate also has half moon shaped lobes with the flat end facing forward facilitate shearing means, said device is including a slider plate on top with elongated slots for backward sliding means and said top plate has a calibration bar attached into which placed is the insert bar said bar will slide further into said calibration bar upon impact.

2. The system of claim 1, wherein said stationary plate has threaded slots for fastening means to said vehicle frame and said plate including a stop bar at the inside end for alignment of the slider plate and will be pushed off when sufficient force is exerted and said plate is made of materials such as, but not limit to, aluminum.

3. The system of claim 2, wherein said stationary plate has cubicle blocks which will be peeled one layer at a time and then being sheared off at the end of the elongated slots.

4. The system of claim 2, wherein said stationary plate has pre-cut notches and directional lines facilitate as chisel and jamming action means, said plate including half moon shaped lobes on the surface with the flat side facing forward for easy calibration of the shearing action.

5. The system of claim 1, wherein said slider top plate is attached with a calibration bar which has numerous calibration through lots and said plate has different lengths of elongated slots for said sliding action of said bar.

6. The system of claim 5, wherein said slider top plate is equipped with triangle shaped chisels which will chisel and jam part of said stationary plate, said slider top plate is made of metal.

7. The system of claim 5, wherein said slider top plate containing different lengths of elongated cavities with the straight ends facing back of the vehicle accommodating said half moon lobes of the stationary plate at the opposite ends which are functioning timed shearing action to mitigate the force of impact from a collision.

8. The system of claim 5, wherein said slider top plate including said elongated cavities with a number of sharp teeth accommodating the cubicle blocks of said stationary plate functioning as peeling and shearing action.

9. The system of claim 5, wherein said slider top plate are torqued down with calculated measure with said cone shaped spring washers, flat washers and nuts which in turn dictate the sliding action of the sliding top plate.

10. The system of claim 5, wherein said slider top plate further including a cover for said calibration bar to keep said calibration rods in place and for appearance purposes.

11. The system of claim 1, wherein said insert bar including said rounded and elongated slots of different lengths for calibration.

12. The system of claim 11, wherein said insert bar further including an attached curve out flex plate to absorb minor impact.

13. The system of claim 11, wherein said insert bar further including a metal sleeve.

14. The system of claim 13, wherein said metal sleeve is pre-shaped and with a slit opening for predictable compression and avoid high yield point when compressed.

15. The system of claim 13, wherein said metal sleeve is further functioning to keep all the calibration rods in place and as well for appearance and keeping dirt out.

16. The system of claim 1, wherein said threaded multi-level bolts are to fasten said stationary plate to the vehicle frame and said top threaded level are torqued down and fastening the slider top plate together with said cone shaped spring washers, flat washers and nuts and said threaded top level of the bolts together with the hardware will be sheared off one at a time giving enough force.
